(19) United States
(12) Patent Application Publication
(10) Pub. No.: US 2021/0029490 A1
(43) Pub. Date: Jan. 28, 2021

(54) SYSTEMS AND METHODS FOR PROVIDING A LOCATION-BASED SERVICE

(71) Applicant: BEIJING DIDI INFINITY TECHNOLOGY AND DEVELOPMENT CO., LTD., Beijing (CN)

(72) Inventors: Yu WANG, Beijing (CN); Zhou YE, Beijing (CN); Min LI, Beijing (CN); Duokun ZHANG, Beijing (CN); Hongfeng WANG, Beijing (CN); Liang CHEN, Beijing (CN)

(73) Assignee: BEIJING DIDI INFINITY TECHNOLOGY AND DEVELOPMENT CO., LTD., Beijing (CN)

(21) Appl. No.: 17/067,788

(22) Filed: Oct. 12, 2020

Related U.S. Application Data
(63) Continuation of application No. PCT/CN2018/082812, filed on Apr. 12, 2018.

(51) Int. Cl. H04W 4/021; H04W 4/029; G06F 16/9537; H04L 29/08

(52) U.S. Cl. CPC H04W 4/021; H04L 67/16; G06F 16/9537; H04W 4/029

(57) ABSTRACT

A system includes a storage medium storing a set of instructions and at least one processor in communication with the storage medium. When executing the instructions, the at least one processor is configured to cause the system to divide an area into a plurality of sub-areas; acquire service information related to at least one service item in each sub-area; determine at least one tag associated with the sub-area based on the service information; determine a target sub-area associated with the terminal device based on the location information of the terminal device; recommend one or more service items in the target sub-area based on the at least one tag associated with the target sub-area; and transmit one or more pieces of service information related to the one or more service items to be presented on the terminal device.

### CROSS-REFERENCE TO RELATED APPLICATIONS

This application is a continuation of International Patent Application No. PCT/CN2018/082812 filed on Apr. 12, 2018, which designates the United States of America, the contents of which are hereby incorporated by reference in their entirety.

### TECHNICAL FIELD

The present disclosure generally relates to location-based service (LBS) platforms, and in particular, to systems and methods for providing service information to users in LBS platforms.

### BACKGROUND

With the development of Internet technology, LBS plays a significant role in people's daily life. For example, location information of a mobile device user has been widely used by advertisers to provide advertisements. Through an online LBS platform, the advertisers may pinpoint consumers' locations and provide location-based service information to be presented on their mobile devices. Thus, it may be desirable to develop systems and methods for providing location-based service information through the LBS platforms efficiently.

### SUMMARY

According to an aspect of the present disclosure, a system may include at least one non-transitory computer-readable storage medium storing a set of instructions and at least one processor in communication with the at least one non-transitory computer-readable storage medium. When executing the set of instructions, the at least one processor may cause the system to divide an area into a plurality of sub-areas. For each sub-area, the at least one processor may cause the system to acquire service information related to at least one service item in the sub-area and determine at least one tag associated with the sub-area based on the service information. The at least one processor may also cause the system to receive location information of a terminal device, and determine a target sub-area associated with the terminal device based on the location information of the terminal device. The at least one processor may further cause the system to recommend one or more service items in the target sub-area based on the at least one tag associated with the target sub-area. The at least one processor may further cause the system to transmit, to the terminal device, one or more pieces of service information related to the one or more service items to be presented on the terminal device.

In some embodiments, for each sub-area, the at least one processor may cause the system to determine one or more rankings of the at least one tag according to temporal information. The at least one processor may also cause the system to acquire time information related to the terminal device and determine one of the one or more rankings based on the time information. The at least one processor may further cause the system to recommend the one or more service items in the target sub-area based on the one of the one or more rankings.

In some embodiments, the at least one processor may cause the system to acquire user information related to the terminal device, and rank the at least one tag associated with the target sub-area based on the user information related to the terminal device. The at least one processor may further cause the system to recommend the one or more service items in the target sub-area based on the ranked at least one tag.

In some embodiments, the user information related to the terminal device may include at least one of profile information, preference information, demand information, or historical information.

In some embodiments, the at least one processor may cause the system to receive a user interaction with one of the one or more service items from the terminal device and recommend one or more additional service items based on the user interaction.

In some embodiments, the at least one processor may also cause the system to receive a user selection of one of the one or more service items from the terminal device and navigate the terminal device to a location where the selected service item is provided.

In some embodiments, the at least one processor may cause the system to acquire demand information regarding to a first tag related to a user of the terminal device. The at least one processor may also cause the system to estimate a time point when the terminal device needs to receive service information related to the first tag based on the demand information related to the first tag. The at least one processor may further cause the system to determine a first sub-area that the terminal device locates at the time point among the plurality of sub-areas based on the location information of the terminal device and designate the first sub-area as the target sub-area.

In some embodiments, the at least one processor may cause the system to recommend one or more service items in the target sub-area based on the first tag.

In some embodiments, the one or more pieces of service information related to the one or more service items may be presented on the terminal device in the form of at least one of text, audio, graph, or video.

According to another aspect of the present disclosure, a computer-implemented method may include one or more of the following operations performed by at least one processor. The method may include dividing an area into a plurality of sub-areas. For each sub-area, the method may include acquiring service information related to at least one service item in the sub-area, and determining at least one tag associated with the sub-area based on the service information. The method may also include receiving location information of a terminal device, and determining a target sub-area associated with the terminal device among the plurality of sub-areas based on the location information of the terminal device. The method may further include recommending one or more service items in the target sub-area based on the at least one tag associated with the target sub-area, and transmitting one or more pieces of service information related to the one or more service items to be presented on the terminal device to the terminal device.

According to yet another aspect of the present disclosure, a non-transitory machine-readable storage medium storing instructions that, when executed by at least one processor of a system, cause the system to perform a method. The method may include dividing an area into a plurality of sub-areas. For each sub-area, the method may include acquiring service information related to at least one service item in the sub-area and determining at least one tag associated with the sub-area based on the service information. The method may also include receiving location information of a terminal device, and determining a target sub-area associated with the terminal device among the plurality of sub-areas based on the location information of the terminal device. The method may further include recommending one or more service items in the target sub-area based on the at least one tag associated with the target sub-area, and transmitting one or more pieces of service information related to the one or more service items to be presented on the terminal device to the terminal device.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary LBS system according to some embodiments of the present disclosure;

FIG. 2 is a schematic diagram illustrating exemplary hardware and software components of an exemplary computing device according to some embodiments of the present disclosure;

FIG. 3 is a schematic diagram illustrating exemplary hardware and/or software components of an exemplary mobile device on which a user terminal may be implemented according to some embodiments of the present disclosure;

FIG. 4 is a block diagram illustrating an exemplary processing engine according to some embodiments of the present disclosure;

FIG. 5 is a flowchart illustrating an exemplary process for providing service information to a terminal device based on location information according to some embodiments of the present disclosure;

FIG. 6 is a flowchart illustrating an exemplary process for recommending one or more service items to a terminal device based on temporal information according to some embodiments of the present disclosure;

FIG. 7 is a flowchart illustrating an exemplary process for recommending one or more service items to a terminal device based on user information according to some embodiments of the present disclosure; and

FIG. 8 is a flowchart illustrating an exemplary process for determining a target sub-area according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to providing service information to a mobile device of a user based on the locations of the user, it should also be understood that the present disclosure is not intended to be limiting. The system or method of the present disclosure may be applied to any other kind of LBS. For example, the system or method of the present disclosure may be applied to transportation systems of different environments including land, ocean, aerospace, or the like, or any combination thereof. The application of the system or method of the present disclosure may be implemented on a user device and include a webpage, a plug-in of a browser, a client terminal, a custom system, an internal analysis system, an artificial intelligence robot, or the like, or any combination thereof.

The term “receiver,” “service receiver”, and “customer” in the present disclosure are used interchangeably to refer to an individual, an entity, or a tool that may receive a service or need to receive a service. Also, the term “service item,” “provider,” and “service provider” in the present disclosure are used interchangeably to refer to an individual, an entity, or a tool that may provide a service or facilitate the providing of the service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for providing service information to users via an LBS system. The systems may perform the methods to divide an area into a plurality of sub-areas. The sub-areas may include one or more service items providing different types of services. For each sub-area, the systems may perform the methods to obtain service information related to the service items, and determine one or more tags associated with the sub-area based on the service information of the service items in the sub-area. The systems may also perform the methods to obtain the location information of the terminal device, and determine a target sub-area among the sub-areas based on the location information of the terminal device. The target sub-area may be a sub-area where the terminal device is located or will be located at a certain time point. The systems may also perform the methods to recommend one or more service items in the target sub-area based on the one or more tags associated with the target sub-area. For example, the tags associated with the target sub-area may be ranked according to, for example, temporal information and/or user information. The service items corresponding to high-ranked tags may be recommended. The systems may further perform the methods to transmit one or more pieces of the service information related to the recommended one or more service items to the terminal device. The one or more pieces of service information may be presented on the terminal device. As such, customized location-based service information may be provided to users efficiently.

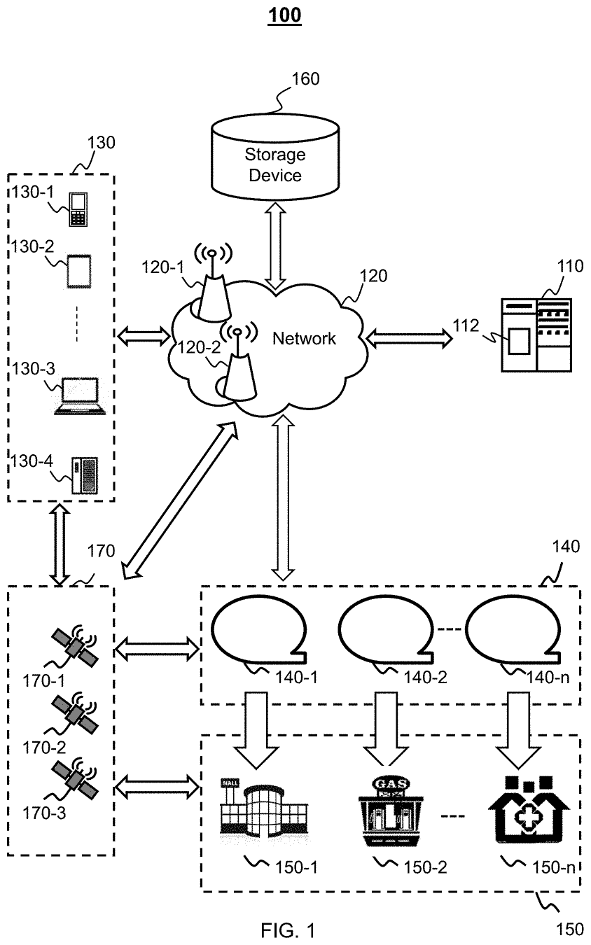

FIG. 1 is a block diagram illustrating an exemplary LBS system 100 according to some embodiments of the present disclosure. The LBS system 100 may include a server 110, a network 120, a service receiver terminal 130, a service provider terminal 140, a service item 150, a storage device 160, and a navigation system 170. In some embodiments, the LBS system 100 may be an online service platform for providing service information to users based on location information of the users. The LBS system 100 may be used in variety of contexts, such as health, object search, entertainment, work, personal life, advertisement.

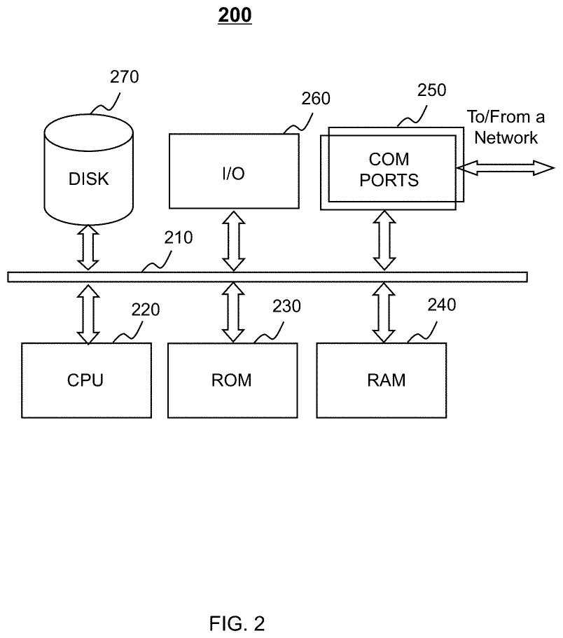

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the service receiver terminal 130, the service provider terminal 140, and/or the storage device 160 via the network 120. As another example, the server 110 may be directly connected to the service receiver terminal 130, the service provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may recommend one or more pieces of service information for a service receiver terminal 130 based on location information of the service receiver terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the LBS system 100 (e.g., the server 110, the service receiver terminal 130, the service provider terminal 140, the storage device 160, and the navigation system 170) may transmit information and/or data to other component(s) of the LBS system 100 via the network 120. For example, the server 110 may receive service information from the service provider terminal 140 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the LBS system 100 may be connected to the network 120 to exchange data and/or information.

In some embodiments, the service receiver terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the service receiver terminal 130 may be a device with positioning technology for locating the position of the service receiver terminal 130.

In some embodiments, the service receiver terminal 130 may be customized to be able to implement the online LBS service. In some embodiments, the service receiver terminal 130 may be a device with positioning technology for locating the service receiver and/or the service receiver terminal 130. In some embodiments, the service receiver terminal 130 may communicate with another positioning device to determine the position of the service receiver and/or the service receiver terminal 130. In some embodiments, the service receiver terminal 130 may continuously or periodically transmit the positioning information to the server 110. For example, the service receiver terminal 130 may transmit the position information to the server 110 each time the user logs into the mobile application associated with the online location-based service.

The service provider terminal 140 may include a plurality of service provider terminals 140-1, 140-2, . . . , 140-n. In some embodiments, the service provider terminal 140 may be similar to, or the same device as the service receiver terminal 130. In some embodiments, the service provider terminal 140 may periodically transmit service information to the server 110. The service information may include promotions, user ratings, or user reviews, or the like, or any combination thereof. For example, the service provider terminal 140 may transmit the service information to the server 110 every thirty minutes. In some embodiments, the service provider terminal 140 may transmit the service information to the server 100 automatically once new service information is released. For example, the service provider terminal 140 may immediately forward the holiday promotions released by Macy's on mid-night of Christmas Eve to the server 110.

In some embodiments, the service provider terminal 140 may correspond to one or more service items 150. The service items 150 may be a place where the service providers provide services. The service items 150 may include a plurality of shops 150-1, gas stations 150-2, . . . , hospitals 150-n. A service item may provide one or more types of services (e.g., a restaurant service, a gas station service, an entertainment service, a bank service, or a travel service).

The storage device 160 may store data and/or instructions. In some embodiments, the storage device 160 may store data obtained from the service receiver terminal 130 and/or the service provider terminal 140. In some embodiments, the storage device 160 may store data and/or instructions that the server 110 may execute or use to perform exemplary methods described in the present disclosure. In some embodiments, storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the LBS system 100 (e.g., the server 110, the service receiver terminal 130, or the service provider terminal 140). One or more components of the LBS system 100 may access the data or instructions stored in the storage device 160 via the network 120. In some embodiments, the storage device 160 may be directly connected to or communicate with one or more components of the LBS system 100 (e.g., the server 110, the service receiver terminal 130, the service provider terminal 140). In some embodiments, the storage device 160 may be part of the server 110.

The navigation system 170 may determine information associated with an object, for example, one or more of the service receiver terminal 130, the service provider terminal 140, the service item 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may transmit the information mentioned above to the network 120, the service receiver terminal 130, the service provider terminal 140, or the service item 150 via wireless connections.

In some embodiments, one or more components of the LBS system 100 (e.g., the server 110, the service receiver terminal 130, the service provider terminal 140) may have permissions to access the storage device 160. In some embodiments, one or more components of the LBS system 100 may read and/or modify information related to the passenger, service provider, and/or the public when one or more conditions are met. For example, the server 110 may read and/or modify one or more drivers' information after a service is completed. As another example, the server 110 may read and/or modify one or more service providers' information after a service is completed.

In some embodiments, information exchanging of one or more components of the LBS system 100 may be initiated by way of detecting a need for service of a service receiver. The object of the service may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the LBS system 100 performs, the element may perform through electrical signals and/or electromagnetic signals. In some embodiments, within an electronic device, such as the service receiver terminal 130, the service provider terminal 140, and/or the server 110, when a processor thereof processes an instruction, transmits out an instruction, and/or performs an action, the instruction and/or action is conducted via electrical signals. For example, when the server 110 transmits out information to service receiver terminal 130 and/or service receiver terminal 130, the server 110 may generate an electrical signal encoding the information. As another example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 on which the server 110, the service receiver terminal 130, and/or the service provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a special purpose computer in some embodiments. The computing device 200 may be used to implement an LBS system for the present disclosure. The computing device 200 may implement any component of the LBS as described herein. In FIGS. 1-2, only one such computer device is shown purely for convenience purposes. One of ordinary skill in the art would understood at the time of filing of this application that the computer functions relating to the LBS as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU, or processor) 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the CPU/processor 220. The methods and/or processes of the present disclosure may be implemented as the program instructions. The computing device 200 may also include an I/O component 260, supporting input/output between the computer and other components therein such as a user interface element 280. The computing device 200 may also receive programming and data via network communications.

Merely for illustration, only one CPU/processor 220 is described in the computing device 200. However, it should be note that the computing device 200 in the present disclosure may also include multiple CPUs/processors, thus operations and/or method steps that are performed by one CPU/processor 220 as described in the present disclosure may also be jointly or separately performed by the multiple CPUs/processors. For example, if in the present disclosure the CPU/processor 220 of the computing device 200 executes both step A and step B, it should be understood that step A and step B may also be performed by two different CPUs/processors jointly or separately in the computing device 200 (e.g., the first processor executes step A and the second processor executes step B, or the first and second processors jointly execute steps A and B).

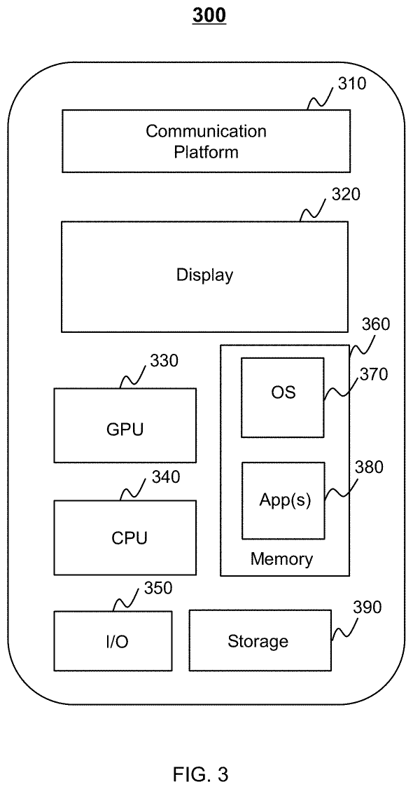

FIG. 3 is a schematic diagram illustrating exemplary hardware and/or software components of an exemplary mobile device 300 on which a use terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the LBS system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

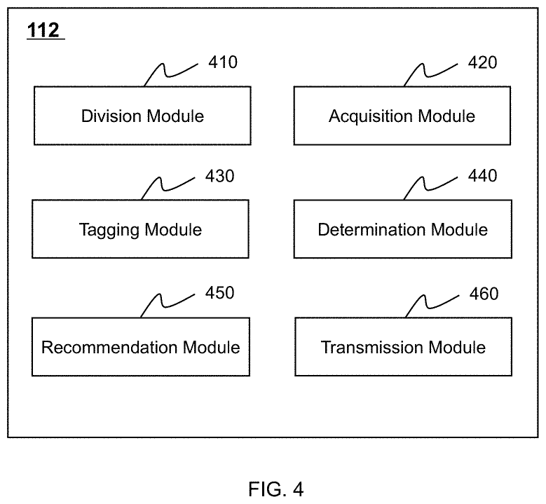

FIG. 4 is a block diagram illustrating an exemplary processing engine 112 according to some embodiments of the present disclosure. The processing engine 112 may include a division module 410, an acquisition module 420, a tagging module 430, a determination module 440, a recommendation module 450, and a transmission module 460. Each module may be a hardware circuit that is designed to perform certain actions, e.g. according to a set of instructions stored in one or more storage media, and/or any combination of the hardware circuit and the one or more storage media.

The division module 410 may be configured to divide an area into a plurality of sub-areas. The area to be divided may be any administrative area, such as but not limited to a country, a province, a city, or a district. In some embodiments, the division module 410 may divide the area into a plurality of sub-areas based on one or more parameters, such as a size of area, a density of population, a division of administrative area, a density of office buildings, a density of residential buildings, longitudinal and latitudinal coordinates, or the like, or any combination thereof. Details regarding the division of the area may be found elsewhere in the present disclosure (e.g., operation 510 and the related descriptions thereof).

The acquisition module 420 may be configured to obtain information and/or instructions related to the LBS system 100. In some embodiments, the acquisition module 420 may obtain information related to an area, a sub-area, a target sub-area, or a terminal device as described elsewhere in this disclosure. For example, the acquisition module 420 may obtain service information related to a service item. The service information related to a service item may include the type of service provided by the service item, business hours, location information, contact information, promotion information, price information, user reviews, user ratings, service features of the service item, operation state, traffic information near the service item, or the like, or any combination thereof. As another example, the acquisition module 420 may obtain location information (e.g., a current location) of a terminal device. As yet another example, the acquisition module 420 may obtain user information related to a user of the terminal device. Exemplary user information related to a user may include profile information, preference information, demand information, historical information, or the like, or any combination thereof.

In some embodiments, the acquisition module 420 may obtain information related to the LBS system 100 from one or more components of the LBS system 100 (e.g., the storage device 160, the service requester terminal 130, and/or the service provider 140). Additionally or alternatively, the acquisition module 420 may obtain information related to the LBS system 100 from another system via the network 120. For example, the acquisition module 420 may obtain information related to the LBS system 100 from a website, a database, a system, and/or any other source that may include information related to the LBS system 100.

The tagging module 430 may be configured to determine one or more tags of an area (or a sub-area of the area). A tag may refer to a keyword or term assigned to an area (or sub-area of the area) describing the types of services provided in the area (or sub-area of the area). In some embodiments, the tagging module 430 may determine the one or more tags of an area by tagging one or more service items in the area based on the types of services provided by the one or more service items. The tags of the one or more service items may be designated as the tags of the area. Details regarding the determination of the one or more tags of an area (or a sub-area of the area) may be found elsewhere in the present disclosure (e.g., operation 530 and the related descriptions thereof).

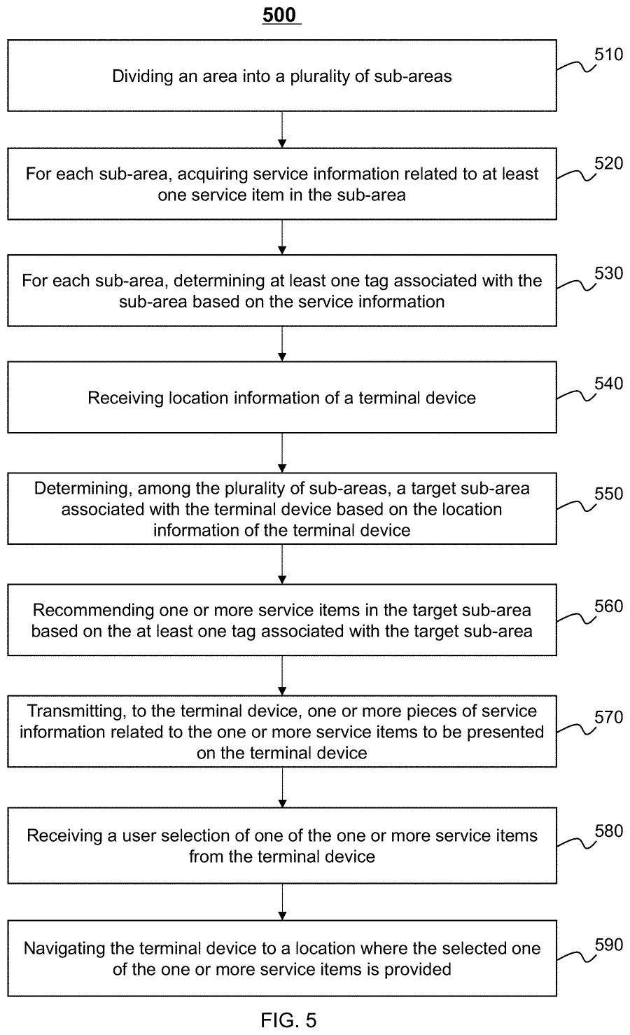

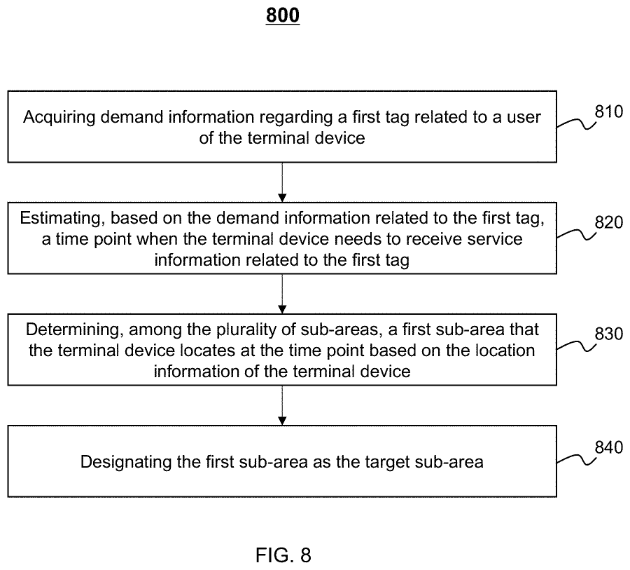

The determination module 440 may be configured to determine a target sub-area associated with a terminal device among a plurality of sub-areas. In some embodiments, the target sub-area may be determined based on location information of the terminal device. For example, the target sub-area may be a sub-area where the terminal device is located at the present moment. As another example, the target sub-area may be a sub-area where the terminal device will be located at a time point. More descriptions regarding the determining of the target sub-area may be found elsewhere in the present disclosure (e.g., FIG. 5, FIG. 8 and the related descriptions). Additionally or alternatively, the determination module 440 may be configured to determine a ranking of one or more tags associated with an area (or a sub-area of the area). For example, the determination module 440 may determine one or more rankings of a plurality of tags associated with a sub-area of an area according to temporal information. As another example, the determination module 440 may determine a ranking of a plurality of tags associated with a sub-area of an area according to user information related to a user of a terminal device.

The recommendation module 450 may be configured to recommend one or more service items in an area (or a sub-area of the area). For example, when a terminal device is at or close to a sub-area of an area, the recommendation module 450 may randomly recommend one or more service items in the sub-area for the terminal device. As another example, the recommendation module 450 may recommend one or more service item in the sub-area according to one or more tags associated with the sub-area. In some embodiments, the recommendation module 450 may rank one or more tags of a sub-area and recommend one or more service items based on the ranking of the tags. In some embodiments, the recommendation module 450 may rank one or more service items corresponding to a same tag and recommend one or more service items based on the ranking of the service items. Details regarding the recommendation of service items may be found elsewhere in the present disclosure (e.g., operation 560 and the relevant descriptions thereof).

The transmission module 460 may be configured to transmit information to one or more components of the LBS system 100 (e.g., a terminal device). For example, the transmission module 460 may transmit one or more pieces of service information related to one or more recommended service items to a terminal device. The one or more pieces of service information may be presented on the terminal device in the form of text, audio, graph, video, or the like, or any combination thereof. Details regarding the transmission of service information to a terminal device may be found elsewhere in the present disclosure (e.g., operation 570 and the relevant descriptions thereof).

It should be noted that the above descriptions of the processing engine 112 is provided for the purposes of illustration, and not intended to limit the scope of the present disclosure. For persons having ordinary skills in the art, various modifications and changes in the forms and details of the application of the above method and system may occur without departing from the principles of the present disclosure. However, those variations and modifications also fall within the scope of the present disclosure. In some embodiments, the processing engine 112 may include one or more other modules. For example, the processing engine 112 may include a storage module to store data generated by the modules in the processing engine 112. As another example, the processing engine 112 may include a navigation module configured to navigate a terminal device to a location. Merely by way of example, the navigation module may transmit one or more instructions to the terminal device to instruct a user of the terminal device to go to the location. In some embodiments, any two of the modules of the processing engine 112 may be combined as a single module, and/or any one of the modules of the processing engine 112 may be divided into two or more units.

FIG. 5 is a flowchart illustrating an exemplary process for providing service information to a terminal device based on location information according to some embodiments of the present disclosure. Process 500 may be executed by the LBS system 100. For example, the process 500 may be implemented as a set of instructions (e.g., an application) stored in storage device 160. In some embodiments, the processing engine 112 may execute the set of instructions and may accordingly be directed to perform the process 500 in an LBS platform. The platform may be an Internet-based platform that connects service providers and receivers through the Internet.

In 510, the processing engine 112 (e.g., the division module 410) may divide an area into a plurality of sub-areas. The area to be divided may be any administrative area, such as a country, a province, a city, a district, or the like. The area may be an area in any location. The sub-areas may be any size or shape. The shapes and/or sizes of different sub-areas may be same or different.

In some embodiments, the division module 410 may divide the area into a plurality of sub-areas based on one or more parameters, such as a size of area, a density of population, a division of administrative area, a density of office buildings, a density of residential buildings, longitudinal and latitudinal coordinates, or the like, or any combination thereof. In some embodiments, the division module 410 may evenly divide the area into sub-areas based on one or more parameters. For example, the division module 410 may divide an area into sub-areas with the same size and shape. The sub-areas may have a polygonal shape, such as a regular triangle, a rectangle, a square, or a regular hexagon. As another example, the division module 410 may divide the area into sub-areas each of which has similar density of office buildings or population.

In some embodiments, the division module 410 may divide the area into sub-areas based on the longitudinal and latitudinal coordinates of the area. For example, the division module 410 may divide the area into the sub-areas based on a Geohash system. In the Geohash system, the longitudinal and latitudinal coordinates of a location may be converted into a Geohash string code. A sub-area (including the locations in the sub-area) may correspond to a Geohash string code.

In some embodiments, the division module 410 may divide the area according to default settings stored in a storage device (e.g., the storage device 160). For example, the size of the sub-areas may be a default value (e.g., 5 square kilometers) stored in the storage device. Additionally or alternatively, the division module 410 may divide the area according to different situations. For example, the size of the sub-areas may be associated with a density of Point of Interests (POIs) of the area. In some embodiments, the division module 410 may divide an area with a high density of POIs (e.g., the density being greater than a threshold) into small sub-areas. The division module 410 may divide an area with a low density of POIs (e.g., the density being less than a threshold) into large sub-areas.

In 520, for each sub-area, the processing engine 112 (e.g., the acquisition module 420) may acquire service information related to at least one service item in the sub-area.

A service item may be a place where a service provider provides a service. The service item may include a restaurant, a shop, a shopping mall, a gas station, a maintenance station, a cinema, a tourist attraction, a museum, a KTV, a hotel, a gym, a theater, a business buildings, a hospital, a school, a bank, or the like, or any combination thereof.

The service information related to a service item may include the type of service provided by the service item, business hours, location information, contact information, promotion information, price information, user reviews, user ratings, service features of the service item, operation state, traffic information near the service item, or the like, or any combination thereof. The type of service provided by the service item may include food service, residential service, shopping service, health service, financial service, education service, auto service, travelling service, cosmetic service, or the like, or any combination thereof. For example, service information related to a KFC may include the type of service provided (food service), the address (3042 Steinway Street, Astoria, N.Y.), the business time (10:00 am-11:00 pm every day), the phone number (718-267-2222), the specialties (hot wings, chicken burger), the number of dinners, the waiting time, or the like, or any combination thereof.

In some embodiments, a service item may include a plurality of sub-service items. The service information related to the service item may include service information related to the one or more sub-service items. For example, a shopping mall may include one or more restaurants, shops, cinemas, KTVs, or the like, or any combination thereof. The service information related to the shopping mall may include service information related to the one or more restaurants, shops, cinemas, KTVs, or the like, or any combination thereof.

The acquisition module 420 may obtain the service information related to the at least one service item in a sub-area from one or more components of the LBS system 100 (e.g., the storage device 160). For example, a service provider in the sub-area may provide and/or update its service information via the service provider terminal 140, and the service information may be stored in the storage device 160. The acquisition module 420 may access the storage device 160 and retrieve the service information related to the at least one service item. Additionally or alternatively, the acquisition module 420 may obtain the service information from another system via the network 120. Another system may include a news platform, an advertising platform, a service provider' website, and/or any other system that may include service information associated with the at least one service item in the sub-area. For example, the acquisition module 420 may obtain promotion information of a shopping mall from an advertising platform. As another example, the acquisition module 420 may obtain the latest menu of a restaurant from the website of the restaurant.

In 530, for each sub-area, the processing engine 112 (e.g., the tagging module 430) may determine at least one tag associated with the sub-area based on the service information.

A tag may refer to a keyword or term assigned to the sub-area describing the types of services provided in the sub-area. A tag related a sub-area may include “food service”, “shopping service”, “health service”, “entertainment service”, “education service”, “residential service”, “financial service”, “travelling service”, “auto service”, “cosmetic service”, or the like, or any combination thereof. A tag of a sub-area may correspond to one or more service items in the sub-area. For example, the tag “shopping service” may correspond to a supermarket, a toy store, a flower store, a convenience store, a wholesale store, or any other place in the sub-area where a consumer may buy a product. As another example, the tag “health service” may correspond to a hospital, a medical center, an urgent center, or any other place in the sub-area where a consumer may receive a health service.

In some embodiments, the tagging module 430 may determine the at least one tag of a sub-area by tagging the at least one service item in the sub-area based on the type of service provided by the at least one service item. The tag(s) of the at least one service item may be designated as the tag(s) of the sub-area. For example, a sub-area may include a McDonald's and a hospital. The tagging module 430 may tagging the McDonald's with a tag “food service” and tagging the hospital with a tag “health service”. The tags associated with the sub-area may be “food service” and “health service”. In some embodiments, the tagging module 430 may tagging a service item with a plurality of tags. For example, a shopping mall may include a variety of service items, for example, a clothing store, a restaurant, and a cinema. The tagging module 430 may tagging the shopping mall with tags “shopping service”, “food service”, and “entertainment service”.

In 540, for each sub-area, the processing engine 112 (e.g., the acquisition module 420) may receive location information of a terminal device. The location information of the terminal device may include a current location, a speed, an acceleration, a direction of the terminal device, or other types of information directly or indirectly associated with location of the terminal device. The current location of the terminal device may include the country, the city, the street, and/or the longitudinal and latitudinal coordinates of the place where the terminal device currently locates. The speed of the terminal device may be an instantaneous speed, an average speed in a time interval (e.g., in the last 1 minute), or the like. The acceleration of the terminal device may be an instantaneous acceleration, an average acceleration in a time interval (e.g., in the last 1 minute), or the like.

In some embodiments, the terminal device may be a device with positioning technology. The acquisition module 420 may continuously or periodically receive location information of the terminal device from the terminal device. Additionally or alternatively, the acquisition module 420 may receive location information of terminal device from the navigation system 170. The navigation system 170 may acquire and/or determine the location information based on a positioning technology. Exemplary positioning technologies may include but are not limited to a global positioning system (GPS) technology, a global navigation satellite system (GLONASS) technology, a Beidou navigation system technology, a Galileo positioning system technology, a Quasi-Zenith satellite systems (QZSS), a base-station positioning technology, a Wi-Fi positioning technology.

In 550, the processing engine 112 (e.g., the determination module 440) may determine a target sub-area associated with the terminal device among the plurality of sub-areas. The target sub-area may be determined based on the location information of the terminal device. For example, the target sub-area may be a sub-area where the terminal device is located at the present moment. As another example, the target sub-area may be the sub-area where the terminal device will be located at a time point. The time point may be any time after the present moment, such as five minutes after the present moment. In some embodiments, the time point may be a demand time when a certain demand of a user of the terminal device needs to be satisfied. More descriptions regarding the determination of the target sub-area based on demand time may be found elsewhere in the present disclosure (e.g., FIG. 8 and the related descriptions).

In 560, the processing engine 112 (e.g., the recommendation module 450) may recommend one or more service items in the target sub-area based on the at least one tag associated with the target sub-area.

In some embodiments, the target sub-area may have a plurality of tags corresponding to a plurality of types of services provided in the target sub-area. The recommendation module 450 may rank the plurality of tags and recommend one or more service items based on the ranking of the tags. The ranking of the tags of the target sub-area may be default settings stored in a storage device (e.g., the storage device 160). The recommendation module 450 may access the storage device 160 and retrieve the default settings of the ranking of the tags.

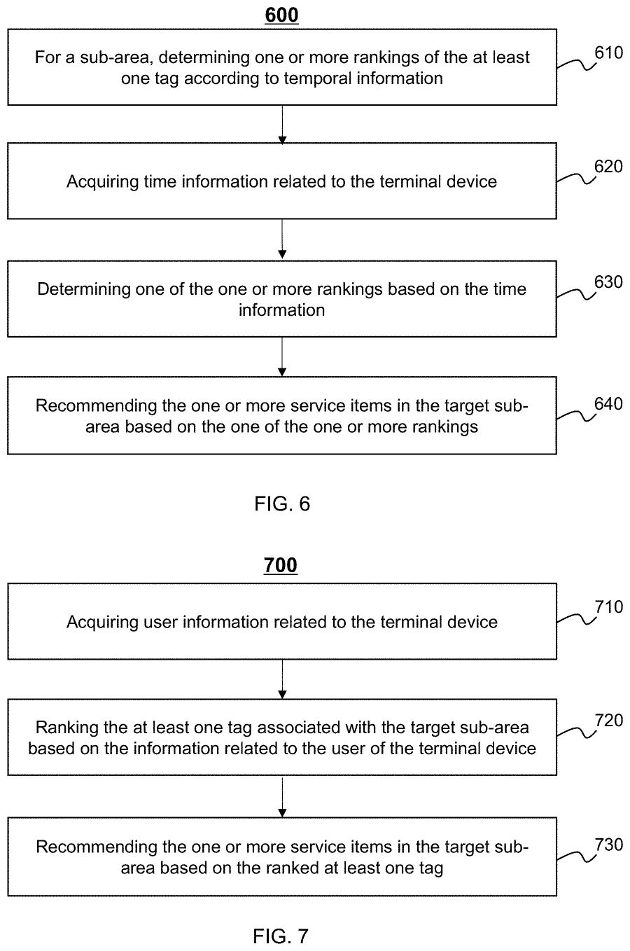

Additionally or alternatively, the ranking of the tags of the target sub-area may be determined by the recommendation module 450 based on, for example, location information, temporal information, user information, or the like, or any combination thereof. The location information may include address, position features of the target sub-area, or the like. For example, the recommendation module 450 may rank the tag “travelling service” at the top if the target sub-area is a famous tourist attraction. The temporal information may include the current time. For example, the recommendation module 450 may rank the tag “food service” at the top when the current time is within or close to dinner time (e.g., 6:00 p.m. to 7:30 p.m.). As another example, the recommendation module 450 may determine one or more rankings of the tags according to temporal information and select a suitable ranking based on the current time. More descriptions regarding the ranking of the tags based on temporal information may be found elsewhere in the present disclosure (e.g., FIG. 6 and the related descriptions). The user information may include but is not limited to profile information, preference information, demand information, or historical information of a user of the terminal device. More descriptions regarding the ranking of the tags based on user information may be found elsewhere in the present disclosure (e.g., FIG. 7 and the related descriptions).

In some embodiments, after ranking the tags of the target sub-area, the recommendation module 450 may determine the recommended service item(s) based on the ranking of tags. For example, the recommendation module 450 may designate a higher recommendation priority to service item(s) corresponding to high-ranked tags than those corresponding to low-ranked tags. As another example, the recommendation module 450 may recommend service item(s) corresponding to top N tags. The N may be any positive integer value (e.g., 1, 2, 3, 4, or 5) or any percentage value (e.g., 10%, 20%, 30%, 40%, or 90%). The N may be a default parameter stored in a storage device (e.g., the storage device 160) or be set manually.

In some embodiments, a plurality of service items in the target sub-area may correspond to a same tag. The recommendation module 450 may rank the service items corresponding to the same tag and recommend one or more service items based on the ranking of the service items. In some embodiments, the service items corresponding to a same tag may be ranked based on service information of the service items. The service information may include but is not limited to location information, promotion information, price information, user ratings, and operation state of the service items as described in connection with 520. For example, restaurants in the target sub-area may be ranked according to their distances to the terminal device in ascending order. The recommendation module 450 may designate a higher recommendation priority to restaurants closer to the terminal device. As another example, the recommendation module 450 may rank the restaurants based on the promotion activities and/or user ratings of the restaurants. The recommendation module 450 may designate a higher priority to restaurants with higher discount and/or higher user ratings.

Additionally or alternatively, the recommendation module 450 may rank the service items corresponding to a tag based on user information of a user of the terminal device. The user information may include profile information, preference information, demand information, or historical information of the user. For example, the recommendation module 450 may rank restaurants in the target sub-area based on historical consumption information of the user. The recommendation module 450 may designate a higher recommendation priority to restaurants that the user has been to. As another example, the recommendation module 450 may designate a higher recommendation priority to Chinese restaurants if the user is a Chinese.

In some embodiments, after ranking the service items corresponding to the same tag, the recommendation module 450 may determine the recommended service item(s) based on the ranking of the one or more service items. For example, the recommendation module 450 may designate a higher recommendation priority to high-ranked service items than low-ranked service items. As another example, the recommendation module 450 may recommend top M service items. The M may be any positive integer value (e.g., 1, 2, 3, 4, or 5) or any percentage value (e.g., 10%, 20%, 30%, 40% or 90%). The M may be a default parameter stored in a storage device (e.g., the storage device 160) or be set manually.

In 570, the processing engine 112 (e.g., the transmission module 460) may transmit one or more pieces of service information related to the one or more recommended service items to be presented on the terminal device. The service information related to a service item may include but is not limited to the type of service provided by the service item, business hours, location information, contact information, promotion information, price information, user reviews, user ratings, service features of the service item, operation state, traffic information near the service item as described in connection with operation 520.

The one or more pieces of service information may be presented on the terminal device in the form of text, audio, graph, video, or the like, or any combination thereof. For example, the transmission module 460 may transmit a text message, a voice message, or a video message listing the one or more pieces of service information related to the recommended service items to the terminal device. In some embodiments, the transmission module 460 may transmit the one or more pieces of service information to an application for LBS service installed in the terminal device. The application may display the one or more pieces of service information on a user interface.

In some embodiments, the tags associated with the target sub-area may be ranked as described in connection with operation 560. The one or more pieces of service information related to the recommended service items may be presented in an order according to the ranking of the at least one tags. For example, service information of service item(s) corresponding to high-ranked tags may be presented on the top of service information list. Additionally or alternatively, the service items corresponding to a same tag may be ranked as described in connection with operation 560. The one or more pieces of service information related to the recommended service item(s) may be presented in an order according to the ranking of the service items. For example, service information related to high-ranked service items may be presented on the top of the service information list.

In some embodiments, the transmission module 460 may transmit the one or more pieces of service information related to different recommended service items at the same time. Additionally or alternatively, the transmission module 460 may transmit the pieces of service information related to different service items at different time. In some embodiments, the tags associated with the target sub-area may be ranked as described in connection with operation 560. The transmission module 460 may transmit the one or more pieces of service information related to service item(s) corresponding to high-ranked tags prior to those corresponding to low-ranked tags. For example, when the ranking of the tags of the target sub-area is “food service”>“residential service”, the transmission module 460 may first transmit pieces of service information of restaurant(s) to the terminal device, and then transmit pieces of service information of hotel(s) after a period (e.g., an hour).

In 580, the processing engine 112 (e.g., the acquisition module 420) may receive a user selection of one of the one or more service items from the terminal device. When the one or more pieces of service information are presented on the terminal device, a user of the terminal device may interact with the one or more pieces of service information. For example, the user may select a service item he/she is interested in by, for example, clicking the service item on a user interface or making a predetermined sound. In some embodiments, when a service item is selected by a user, the terminal device may display more service information regarding the selected service item.

In 590, the navigation system 170 may navigate the terminal device to a location where the selected service item is provided. In some embodiments, the navigation system 170 may navigate the terminal device to the location where the selected service item is provided based on the location information of the terminal device and the selected service item. The location information of the selected service item may be included in the service information of the selected item as described in connection with operation 520. The acquisition of the location information of the terminal device may be similar to that as described in connection with operation 540, and the detailed descriptions thereof are not repeated here.

In some embodiments, the navigation system 170 may transmit one or more instructions to the terminal device. The instructions may instruct the user of the terminal device to go to the location where the selected service item is provided. The instructions may indicate a position of the selected service item, a distance between the terminal device and the selected service item, a moving direction, an estimated time for arriving, or the like, or any combination thereof. In some embodiments, the terminal device may display the instructions on an interface in the form of text, audio, graph, video, or the like, or any combination thereof. For example, the terminal device may broadcast the instructions. Additionally or alternatively, the terminal device may display graph instructions.

It should be noted that the above descriptions of process 500 are provided for the purposes of illustration, and not intended to limit the scope of the present disclosure. For persons having ordinary skills in the art, various modifications and changes in the forms and details of the application of the above method and system may occur without departing from the principles in the present disclosure. However, those variations and modifications also fall within the scope of the present disclosure.

In some embodiments, the order of the operations in the process 500 may be changed. For example, operation 540 may be performed before operation 510. In some embodiments, one or more operations may be added or omitted. For example, operation 580 and/or operation 590 may be omitted. As another example, operations 510 to 530 may be omitted. One or more tags of the plurality of sub-areas in an area of the LBS system 100 may be determined and stored in a storage device (e.g., a storage device 160, an external storage device). The acquisition module 420 may access the storage device and retrieve the one or more tags of the plurality of sub-areas. As another example, before 590, the acquisition module 420 may receive a request for navigation from the terminal device. The navigation system 170 may navigate the terminal device after receiving the request for navigation.

In some embodiments, the acquisition module 420 may receive a user interaction with one of the one or more service items from the terminal device. The recommendation module 450 may recommend one or more additional service items based on the user interaction. In some embodiments, the recommendation module 450 may recommend one or more service items based on a user selection of one of the one or more service items. For example, the recommendation module 450 may recommend one or more additional service items providing similar services to the selected service item. As another example, the recommendation module 450 may recommend one or more additional service items that have a same tag as the selected service item.

In some embodiments, if the user does not select any of the one or more recommended service items, the recommendation module 450 may recommend one or more additional service items to the terminal device until receiving a user selection of a service item or the number of recommended service items is greater than a threshold. Additionally or alternatively, if the user does not select any of the recommended one or more service items, the recommendation module 450 may recommend one or more other types of services for the terminal device, such as a music service, a broadcast service, or the like, or any combination thereof. The transmission module 460 may transmit the recommended service(s) to the terminal device.

FIG. 6 is a flowchart illustrating an exemplary process for recommending one or more service items to a terminal device based on temporal information according to some embodiments of the present disclosure. Process 600 may be executed by the LBS system 100. For example, the process 600 may be implemented as a set of instructions (e.g., an application) stored in storage device 160. In some embodiments, the processing engine 112 may execute the set of instructions and may accordingly be directed to perform the process 600 in an LBS platform. The platform may be an Internet-based platform that connects service providers and receivers through the Internet. In some embodiments, the process 600 may be performed to achieve operation 560 as described in connection with FIG. 5.

In 610, for each sub-area, the processing engine 112 (e.g., the recommendation module 450) may determine one or more rankings of the at least one tag according to temporal information.

The temporal information may include a time point, a time interval (e.g., rush hours, day-time), a date section (e.g., a weekday, a weekend, a holiday, or a festival), or the like, or any combination thereof. For example, the temporal information may be rush hours (e.g., 8:00 a.m. to 10:00 a.m.) on weekdays. As another example, the temporal information may be dinning time (e.g., 12:00 a.m. to 12:30 p.m.). In some embodiments, a day may be divided into a plurality of time intervals. The recommendation module 450 may determine one or more rankings of tags corresponding to the plurality of time intervals. The duration of a time interval may be, for example, 0.5 hours, 1 hour, 2 hours, 3 hours, or 5 hours. The duration of the time interval may be set manually or be determined by one or more components of the LBS system 100 (e.g., the recommendation module 450) according to different situations.

In some embodiments, the target sub-area may have plurality of tags. The ranking of the tags at different time may be same or different. In some embodiments, the recommendation module 450 may determine different rankings at different time because users normally have different demand at different time. For example, during the dinner time (e.g., 6:00 p.m. to 7:30 p.m.), the ranking of the tags in the sub-area may be “food service”>“entertainment service”>“auto service”. As another example, in the time period of 13:00 pm to 14:00 pm, the ranking of the tags in the sub-area may be “auto service”>“entertainment service”>“food service”. “Service item A>Service item B” may indicate that the service item A has a higher recommendation priority than the service item B.

In some embodiments, the one or more rankings of tags at different time may be determined based on historical information of one or more users. For example, the recommendation module 450 may analyze users' historical information (e.g., consumption information) to determine users' demand for services at different time. The recommendation module 450 may determine one or more rankings of tags according to user's demand for services at different time.

In 620, the processing engine 112 (e.g., the acquisition module 420) may acquire time information related to the terminal device. The time information related to the terminal device may include a time point or interval when the terminal device is at or close to the target sub-area (e.g., the distance between the terminal device and the target sub-area is within a threshold).

In 630, the processing engine 112 (e.g., the determination module 440) may determine one of the one or more rankings based on the time information related to the terminal device. For example, the ranking of the tags in the sub-area may be “food service”>“auto service” between 12:00 a.m. and 12:30 p.m. and “auto service>“food service” between 13:00 p.m. and 14:00 p.m. When the terminal device arrivals at the target sub-area at 13:30 p.m., the determination module 440 may determine that the ranking of the tags is “auto service>“food service”.

In 640, the processing engine 112 (e.g., the recommendation module 450) may recommend one or more service items in the target sub-area based on the determined ranking of the at least one tag. In some embodiments, the recommendation module 450 may designate a higher recommendation priority to service items corresponding to high-ranked tags than those corresponding to low-ranked tags. In some embodiments, the recommendation module 450 may rank the service items corresponding to the same tag and recommend one or more service items based on the ranking of the service items. More descriptions regarding the recommendation of the service items may be found elsewhere in the present disclosure (e.g., operation 560 and the relevant descriptions thereof).

It should be noted that the above descriptions of process 600 are provided for the purposes of illustration, and not intended to limit the scope of the present disclosure. For persons having ordinary skills in the art, various modifications and changes in the forms and details of the application of the above method and system may occur without departing from the principles in the present disclosure. However, those variations and modifications also fall within the scope of the present disclosure. In some embodiments, one or more operations may be added or omitted. For example, operation 610 may be omitted. The recommendation module 450 may acquire one or more rankings of the tags corresponding to different time from one or more components of the LBS system 100 (e.g., the storage device 160).

FIG. 7 is a flowchart illustrating an exemplary process for recommending one or more service items to a terminal device based on user information according to some embodiments of the present disclosure. Process 700 may be executed by the LBS system 100. For example, the process 700 may be implemented as a set of instructions (e.g., an application) stored in storage device 160. In some embodiments, the processing engine 112 may execute the set of instructions and may accordingly be directed to perform the process 700 in an LBS platform. The platform may be an Internet-based platform that connects service providers and receivers through the Internet. In some embodiments, the process 700 may be performed to achieve operation 560 as described in connection with FIG. 5.

In 710, the processing engine 112 (e.g., the acquisition module 420) may acquire user information related to the terminal device. The user information may include information related to a user of the terminal device, such as profile information, preference information, historical information of the user, demand information, or the like, or any combination thereof. The profile information may include a name, gender, age, a nationality, a hometown, an occupation, an education attainment, hobbies, or the like, or any combination thereof. The preference information may include information indicating user's preference of different types of services, service items, service time, service locations, or the like, or any combination thereof. The historical information may include historical service orders, historical consumption information, historical location information, or the like, or any combination thereof. The demand information may include information indicating users' demand for a type of service or a service item, a time point the demand needs to be satisfied, or the like. In some embodiments, the preference information and/or the demand information may be determined by analyzing user's historical information.

The acquisition module 420 may acquire the user information from one or more components of the LBS system 100 (e.g., the storage device 160, the service provider terminal 140, or the service receiver terminal 130). In some embodiments, a user may provide his or her user information to the LBS system 100. The user information may be stored in the storage device (e.g., the storage device 160). The acquisition module 420 may access the storage device and retrieve the user information related to the user. Additionally or alternatively, the acquisition module 420 may obtain the user information from another source, such as a website, a database, a system, and/or any other source that may include user information. For example, the acquisition module 420 may acquire user information from a social-networking site, an online shopping website, a hospital website, a ticket booking website, or the like.

In 720, the processing engine 112 (e.g., the recommendation module 450) may rank the at least one tag associated with the target sub-area based on the user information related to the user of the terminal device. For example, the recommendation module 450 may rank a plurality of tags based on the gender of the user. The tag “shopping” may have a higher ranking for a female than a male. As another example, the recommendation module 450 may rank a plurality of tags based on the preference information of the user. The recommendation module 450 may rank the tag “travelling service” at the top if the user likes travelling.

In 730, the processing engine 112 (e.g., the recommendation module 450) may recommend one or more service items in the target sub-area based on the ranked at least one tag. In some embodiments, the recommendation module 450 may designate a higher recommendation priority to service item(s) corresponding to high-ranked tags than those corresponding to low-ranked tags. In some embodiments, the recommendation module 450 may rank the service items corresponding to a same tag and recommend one or more service items based on the ranking of the service items. More descriptions regarding the recommendation of the one or more service items in the target sub-area may be found elsewhere in the present disclosure (e.g., operation 560 and related descriptions).

FIG. 8 is a flowchart illustrating an exemplary process for determining a target sub-area associated with the terminal device according to some embodiments of the present disclosure. Process 800 may be executed by the LBS system 100. For example, the process 800 may be implemented as a set of instructions (e.g., an application) stored in storage device 160. In some embodiments, the processing engine 112 may execute the set of instructions and may accordingly be directed to perform the process 800 in an LBS platform. The platform may be an Internet-based platform that connects service providers and receivers through the Internet. In some embodiments, the process 800 may be performed to achieve operation 550 as described in connection with FIG. 5.

In 810, the processing engine 112 (e.g., the acquisition module 420) may acquire demand information regarding a first tag related to a user of the terminal device. The first tag may be a keyword or term describing a type of service provided in a sub-area as described in connection with FIG. 5. The first tag may include “food service”, “shopping service”, “health service”, “entertainment service” or the like, or any combination thereof. The demand information may include information indicating a user's demand for the type of service corresponding to the first tag. For example, the user of the terminal device may be a driver and the first tag may be “vehicle refueling service”. The demand information related to “vehicle refueling service” may include the historical time of refueling, the historical amount of refueling, the driving distance, the fuel consumption of the vehicle, or other information indicating the user's demand for a vehicle refueling service.

In some embodiments, the acquisition module 420 may acquire the demand information from one or more components of the LBS system 100 (e.g., the storage device 160, the service provider terminal 140). Additionally or alternatively, the acquisition module 420 may acquire the demand information from another source, such as a website, a database, a system, and/or any other source that may include demand information related to the user via the Network 120. For example, the acquisition module 420 may acquire demand information related to the tag “vehicle refueling service” from a website or a database of gas stations.

In 820, the processing engine 112 (e.g., the determination module 440) may estimate a time point when the terminal device needs to receive service information related to the first tag based on the demand information related to the first tag. The time point when the terminal device needs to receive service information related to the first tag may be an estimated time point when the user's demand needs to be satisfied. For example, the determination module 440 may estimate a time point when the user needs a refueling service based on his/her demand information related to the tag “vehicle refueling service”.

In 830, the processing engine 112 (e.g., the determination module 440) may determine a first sub-area among the plurality of sub-area that the terminal device locates at the time point based on the location information of the terminal device. The location information of the terminal device received from the terminal device and/or the positioning system 170 as described in connection with operation 540. The location information may include a current location, a speed, an acceleration, a direction of the terminal device, traffic information, or other types of information directly or indirectly associated with location of the terminal device. In some embodiments, the determination module 440 may estimate the first sub-area based on the location information of the terminal device. Additionally or alternatively, the acquisition module 420 may acquire the location information of the terminal device at or near the time point, and determine the first sub-area based on the location information.

In 840, the processing engine 112 (e.g., the determination module 440) may designate the first sub-area as the target sub-area.

In some embodiments, when the terminal device is at or close to the target sub-area, the recommendation module 450 may recommend one or more service items in the target sub-area corresponding to the first tag. The transmission module 470 may transmit one or more pieces of service information to the terminal device. The pieces of service information may be related to the recommended one or more service items to be presented on the terminal device. For example, the first tag may be “vehicle refueling service”. The recommendation module 450 may recommend one or more gas stations in the target sub-area. The transmission module 460 may transmit one or more pieces of information related to the recommended one or more gas stations to the terminal device when the terminal device is at or close to the target sub-area. More descriptions regarding the recommendation of service items and transmission of service information may be found elsewhere in the present disclosure (e.g., FIG. 5 and related descriptions).

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for providing a location-based service, comprising:
at least one non-transitory computer-readable storage medium including a set of instructions;
at least one processor in communication with the at least one non-transitory computer-readable storage medium, wherein when executing the instructions, the at least one processor is directed to cause the system to:
divide an area into a plurality of sub-areas;
for each sub-area,
acquire service information related to at least one service item in the sub-area; and
determine at least one tag associated with the sub-area based on the service information;
receive location information of a terminal device;
determine, among the plurality of sub-areas, a target sub-area associated with the terminal device based on the location information of the terminal device;
recommend one or more service items in the target sub-area based on the at least one tag associated with the target sub-area; and
transmit, to the terminal device, one or more pieces of service information related to the one or more service items to be presented on the terminal device.

2. The system of claim 1, wherein to recommend one or more service items in the target sub-area based on the at least one tag associated with the target sub-area, the at least one processor is further directed to cause the system to:
for each sub-area, determine one or more rankings of the at least one tag according to temporal information;
acquire time information related to the terminal device;
determine one of the one or more rankings based on the time information; and
recommend the one or more service items in the target sub-area based on the one of the one or more rankings.

3. The system of claim 1, wherein to recommend one or more service items in the target sub-area based on the at least one tag associated with the target sub-area, the at least one processor is further directed to cause the system to:
acquire user information related to the terminal device;
rank the at least one tag associated with the target sub-area based on the user information related to the terminal device; and
recommend the one or more service items in the target sub-area based on the ranked at least one tag.

4. The system of claim 3, wherein the user information related to the terminal device includes at least one of profile information, preference information, demand information, or historical information.

5. The system of claim 1, wherein the at least one processor is further directed to cause the system to:
receive a user interaction with one of the one or more service items from the terminal device; and
recommend one or more additional service items based on the user interaction.

6. The system of claim 1, wherein the at least one processor is further directed to cause the system to:
receive a user selection of one of the one or more service items from the terminal device; and
navigate the terminal device to a location where the selected service item is provided.

7. The system of claim 1, wherein to determine the target sub-area associated with the terminal device based on the location information of the terminal device, the at least one processor is further directed to cause the system to:
acquire demand information regarding to a first tag related to a user of the terminal device;
estimate, based on the demand information related to the first tag, a time point when the terminal device needs to receive service information related to the first tag;
determine, among the plurality of sub-areas, a first sub-area that the terminal device locates at the time point based on the location information of the terminal device; and
designate the first sub-area as the target sub-area.

8. The system of claim 7, wherein to recommend one or more service items based on the at least one tag associated with the target sub-area, the at least one processor is further directed to cause the system to:
recommend one or more service items in the target sub-area based on the first tag.

9. The system of claim 1, wherein the one or more pieces of service information related to the one or more service items are presented on the terminal device in the form of at least one of text, audio, graph, or video.

10. A method for providing a location-based service implemented on a computing device having at least one non-transitory computer-readable storage medium and at least one processor, the method comprising:
dividing an area into a plurality of sub-areas;
for each sub-area,
acquiring service information related to at least one service item in the sub-area; and
determining at least one tag associated with the sub-area based on the service information;
receiving location information of a terminal device;
determining, among the plurality of sub-areas, a target sub-area associated with the terminal device based on the location information of the terminal device;
recommending one or more service items in the target sub-area based on the at least one tag associated with the target sub-area; and
transmitting, to the terminal device, one or more pieces of service information related to the one or more service items to be presented on the terminal device.

11. The method of claim 10, wherein the recommending one or more service items in the target sub-area based on the at least one tag associated with the target sub-area further comprises:
for each sub-area, determining one or more rankings of the at least one tag according to temporal information;
acquiring time information of the terminal device;
determining one of the one or more rankings based on the time information; and
recommending the one or more service items in the target sub-area based on the one of the one or more rankings.

12. The method of claim 10, wherein the recommending one or more service items in the target sub-area based on the at least one tag associated with the target sub-area further comprises:
acquiring user information related to the terminal device;
ranking the at least one tag associated with the target sub-area based on the user information related to the terminal device; and
recommending the one or more service items in the target sub-area based on the ranked at least one tag.

13. The method of claim 12, wherein the user information related to the terminal device includes at least one of profile information, preference information, demand information, or historical information.

14. The method of claim 10, further comprises:
receiving a user interaction with one of the one or more service items from the terminal device; and
recommending one or more additional service items based on the user interaction.

15. The method of claim 10, further comprises:
receiving a user selection of one of the one or more service items from the terminal device; and
navigating the terminal device to a location where the selected service item is provided.

16. The method of claim 10, wherein the determining the target sub-area associated with the terminal device based on the location information of the terminal device further comprises:
acquiring demand information regarding a first tag related to a user of the terminal device;
estimating, based on the demand information related to the first tag, a time point when the terminal device needs to receive service information related to the first tag;
determining, among the plurality of sub-areas, a first sub-area that the terminal device locates at the time point based on the location information of the terminal device; and
designating the first sub-area as the target sub-area.

17. The method of claim 16, wherein the recommending one or more service items based on the at least one tag associated with the target sub-area further comprises:
recommending one or more service items in the target sub-area based on the first tag.

18. The method of claim 10, wherein the one or more pieces of service information related to the one or more service items are presented on the terminal device in the form of at least one of text, audio, graph, or video.

19. A non-transitory computer readable medium embodying a computer program product, the computer program product comprising instructions configured to cause a computing device to:
divide an area into a plurality of sub-areas;
for each sub-area,
acquire service information related to at least one service item in the sub-area; and
determine at least one tag associated with the sub-area based on the service information;
receive location information of a terminal device;
determine, among the plurality of sub-areas, a target sub-area associated with the terminal device based on the location information of the terminal device;
recommend one or more service items in the target sub-area based on the at least one tag associated with the target sub-area; and
transmit, to the terminal device, one or more pieces of service information related to the one or more service items to be presented on the terminal device.
